(19) United States
(12) Patent Application Publication
(10) Pub. No.: US 2011/0148117 A1
(43) Pub. Date: Jun. 23, 2011

(54) UNDERWATER TURBINE WITH FINNED DIFFUSER FOR FLOW ENHANCEMENT

(76) Inventor: Ralph-Peter Bailey, Steyning (GB)

(21) Appl. No.: 13/058,825

(22) PCT Filed: Aug. 11, 2009
(86) PCT No.: PCT/GB09/01967

§ 371 Date: Feb. 11, 2011

Related U.S. Application Data
(60) Provisional application No. 61/087,987, filed on Aug. 11, 2008.

(51) Int. Cl. F01D 15/10; F03G 7/00

(52) U.S. Cl. 290/52; 415/8

(57) ABSTRACT

A submerged flow augmented shrouded turbine power generation system with a forward flow compression section (11) and an aft multi-finned diffuser section (14) with a centrally supported generator (12) powered by turbine blades (15) optimized to be driven by the enhanced flow field created by the forward cowl and aft diffuser/fin sections. The system can be positively buoyant and tethered to the seafloor (18) or negatively buoyant and tethered to the underside of a vessel or offshore structure, or it can be attached directly to the underside of a vessel or offshore structure. An array of such systems can be placed on the seafloor to create a distributed power generation network. An array of such systems can also be placed on the seafloor to directly pump seawater to an energy storage device or a central desalination plant.

### FIELD OF THE INVENTION

The present application relates to the use of hydrodynamic devices to enhance the pressure differential across an underwater fluid turbine to increase the power yield per unit area. The present application discloses an underwater fluid turbine encased in a multi dimensional shroud to enhance the pressure differential across the turbine for generating electricity thereby augmenting turbine efficiency and reducing the turbine diameter required to generate a desired amount of power.

### BACKGROUND OF THE INVENTION

The use of a shroud to accelerate water through a turbine is a well-known and practiced discipline. In the open ocean, the harnessing of currents has been dominated by large bladed turbines, analogous to wind turbines on land. In fact, on land, Diffuser Augmented Wind Turbines (DAWTs) have been known for many years to enable blade diameter to be smaller because they create a greater pressure differential across the blade, so blade speed is increased which also makes for a lower cost and higher efficiency electrical generator. Because power scales with velocity to the third power, a small diameter fast spinning blade can generate as much power as a large diameter slow spinning blade. For an underwater turbine definitions used here include:

Cowling—front part of housing that attracts and then focuses the flow in front of the turbine.
Diffuser—rear part of housing that expands the flow to generate suction behind the turbine.
Duct—central core of the housing in which the turbine is located.
Shroud—the entire structure surrounding the turbine including the cowling, duct, and diffuser
Vane or fin—a hollow protruding structure comprising of part of the diffuser, to direct internal and external flow, which may or may not have pitch (helix) either axially or radially.

During the late 1970s energy crises, a great many windmill designs and patents evolved including those for shrouded windmills. For example, U.S. Pat. No. 4,075,500 describes a diffuser augmented wind turbine electrical generating system where the diffuser helps to focus the wind energy on the blade and as the diffuser increases in diameter downstream of the turbine blades, it increases the pressure differential across the blades which increases the speed of the blades and hence the amount of power that can be generated. This patent describes servo controllable airfoil stator inlet wings to adjust the turbine speed which at the time was needed because generators wanted to run at more constant speeds. Currently, advanced solid state electronics can overcome this issue.

The use of a shroud requires that the flow inside the shroud should not separate or the pressure differential enhancement effect will be lost. In U.S. Pat. No. 4,075,500 holes 34 allow external air to flow in and enter the shroud downstream of the turbine blades which energizes the boundary layer and keeps it from separating along the inner wall of the diffuser. U.S. Pat. No. 4,132,499 shows more complex internal passages to collect and distribute air from the outside of a duct and deliver it to the inside of the duct to achieve a similar effect. U.S. Pat. No. 4,422,820 shows spoiler grooves which also collect and distribute air from the outside of a duct and deliver it to the inside of the duct to energize the boundary layer. A potential problem with these holes though is increased cost to manufacture while the potential for fouling and loss of function with time is increased.

U.S. Pat. No. 4,132,499 also shows a secondary circular wing at the downstream side of the diffuser which helps create a greater pressure drop across the turbine with a shorter overall length of the diffuser system. The secondary wing concept is taken to the next step in U.S. Pat. No. 5,324,985, where it is made in sections that are angularly controllable. Slots between sections of the duct help to energize the boundary layer with external high speed air. U.S. Pat. No. 7,018,166 uses a free-spinning rotor downstream of the wind turbine to also more actively control flow to reduce separation. U.S. Pat. No. 7,094,018 uses an arcuate shape diffuser to attempt to also better control the flow.

The same can be said for turbines that operate in a liquid, see for example F. L. Ponta, P. M. Jacovkis “Marine-current power generation by diffuser-augmented floating hydro-turbines” Renewable Energy 33 (2008) 665-673, which shows a ducted water turbine in the open ocean can be more desirable than large spinning blades, especially with regard to the protection of large wildlife. However, ocean based turbines are typically attached to the seafloor with a structure such as a pylon, and wave forces at the surface can be most significant.

The present invention is differentiated from previous ducted designs by aft fins (generally helical when designed to be spinning) on the diffuser. The aft fins can be helical and mounted such that they are free to rotate by the external fluid flow which causes the fluid to counter swirl with respect to the turbine as it is drawn through the center of the cowling past internal turbine blades and thereby significantly enhance flow speed augmentation. The fins can also be mounted in a stationary manner to the diffuser and still impart a counter swirl to that created by the turbine, increasing its efficiency. Other novel hydrodynamic devices disclosed further increase the efficiency. Additionally the design enables the invention to be tethered underwater and flown like a kite. Hence it can be deployed for lower cost because it does not need a tower or pylon for support.

### SUMMARY OF THE INVENTION

A preferred aim of this invention, therefore, is to provide a new and improved shroud with forward cowling, center duct section, and aft diffuser with swirl inducing fins to enhance fluid flow past the turbine blades while reducing the overall size of the shroud compared to current designs.

A further preferred aim of this invention is to enhance the hydrodynamic performance of the shroud with flow control and mixing features that will further increase turbine power.

A further preferred aim of this invention is to provide a rotating diffuser that can extract more energy out of the free flow than a static diffuser and convert this into increased turbine power.

A further preferred aim of this invention is to provide the rotating diffuser with open-ended hollow helical fins where flow on the outside of the shroud causes the diffuser to rotate and the hollow inside of the helical fins thus acts as a pump to further increase the flow past the turbine blades.

A further preferred aim of this invention to design the unit such that it can be flown like a kite to enable it to naturally line up axial to the flow direction, and to reduce its infrastructure and operating costs compared to fixed installations.

A further preferred aim of this invention is to extract power from the marine version of this turbine using pressurized water hydraulics, and then to store power against a vacuum or pressure reservoir to provide for a more consistent power output.

A further preferred aim of this invention is to enable alternative cowls and diffusers to be readily exchanged so that the desired drag level and optimum performance for a given flow speed can be attained.

In accordance with a first aspect of the invention there is provided a rotating diffuser to accelerate flow through a ducted turbine that is driven round by the fluid flow outside of the duct by hydrodynamic forces acting on the diffuser's hollow fins, said fins extend out from the duct with an angle of attack to the flow direction as a flowing continuation of its inside and outside surfaces permitting the ready flow of fluid from inside the duct into them, from where the fluid is accelerated centrifugally by the rotation of the diffuser before exiting at the open trailing edges where it is again accelerated by Venturi effect suction resulting from the trailing edges movement through the fluid.

A further aspect of the invention provides a static diffuser to accelerate flow through a turbine duct with a radial array of convolutions which extend out in a radial spiral so as to expand the internal flow within the limits of retaining laminar flow, with the convolutions being biased so as to produce a counter-swirl to that produced by the turbine.

A further aspect of the invention provides a convoluted or finned stationary (static) or rotating diffuser to accelerate fluid flow through a duct where the trailing edges of the diffuser convolutions have secondary convolutions that may modulate both backwards and forwards as well as up and down, being then blended back into the diffusers surface. Preferably the secondary convolutions may have tertiary convolutions or regressing even further to yet smaller convolutions where the structure is large enough. Preferably the convolutions are circumscribed by a secondary radial wing significantly following the sweep of the trailing edge, such wing having the form of an inverted aerofoil operating at a negative angle of attack to the prevailing fluid flow.

A further aspect of the invention provides tubercle-like protrusions that advance and retard the leading edge of a turbine housing duct in order to reduce the high pressure zone where the leading edge is nearly normal to the flow direction.

A further aspect of the invention provides convolutions in the face of a diffuser structure that have a soft climb ramp followed by a steep precipice lying at a small angle to the prevailing fluid flow and advantageously deepening in the flow direction that cause the generation of vortices that gain strength as they entrain more fluid as they deepen.

A further aspect of the invention provides a submerged turbine power generation system comprising one or more turbine units each designed to fly on a harness such that they naturally line up into the prevailing fluid flow and sustain their elevation by using both buoyancy and hydrodynamic lift forces that vary in proportion to flow speed. Preferably multiple units are connected in a series harness enabling a vertically arranged stack to be retained by a single anchor point.

A further aspect of the invention provides a turbine power generation device comprising: (a) a forward duct portion; (b) a fluid flow accelerating aft multi-finned diffuser; and (c) a means of extracting power from the flow through the duct, wherein said device is buoyant. Preferably the device further comprises any one or more of: (d) a line for restraining the device to an anchor point on a sea bed; (e) a power cable for transferring power generated to an anchor point; (f) a keel; (g) a central electrical generator driven by turbine blades; (h) a central fluid pump driven by turbine blades; (i) support structure anchoring generator or pump to outer support structure; (j) anchoring attachment points on an outer support structure; (k) an anchor system; and/or (l) fluid flow lines transferring pressurized water to a reverse osmosis filtration system. In a preferred embodiment the anchor system is attached to the seafloor and the power generation device has slight positive buoyancy. In an alternative embodiment the anchor system is attached to a surface vessel or structure and the power generation device has slight negative buoyancy. In another embodiment, the device is attached directly to a structure such as a boat.

A further aspect of the invention provides an array of turbine power generation devices as described herein, the array being placed on the seafloor to create a distributed power generation network. Preferably, the array is anchored to the seafloor to create a desalination plant.

A further aspect of the invention provides a marine turbine power generation system comprising multiple submerged turbine power generator devices as described herein, wherein each generator device has its own variable capacity hydraulic pump connected by pressure line to a common gas filled pressure reservoir, and wherein the pressure reservoir has a hydraulic motor that drives an electric generator at constant rate or on demand as it releases the pressurized water.

A further aspect of the invention provides a marine turbine power generation system comprising multiple submerged generator devices as described herein, each generator having its own variable capacity hydraulic pump connected by pressure line to a pressure vessel otherwise water filled but able to be evacuated against the resulting near vacuum, the pressure reservoir having a hydraulic motor that drives an electric generator at constant rate or on demand as it returns water into the evacuated space.

A further aspect of the invention provides a submerged turbine desalination system comprising multiple submerged generator devices as described herein, wherein each generator has its own variable capacity hydraulic pump connected by pressure line to a common reverse osmosis filtration system.

A further aspect of the invention provides a modular exchangeable cowl and or diffuser applied to a small scale marine generator system as may be employed by boat owners who may want to use it both for slow speed currents when moored and higher flow speeds when underway, or even on deck for wind generation. A further aspect of the invention provides a modular exchangeable power pod for such a marine generator, where various power pod options may generate electricity, pressurize fluid for desalination or compress gas for air conditioning.

A further aspect of the invention provides a submerged turbine power generation system comprising: (a) an outer support structure; (b) a fluid flow enhancing front diffuser portion of the support structure; (c) a fluid flow enhancing aft multi-finned portion of the support structure; (d) turbine blades; (e) a central generator driven by turbine blades; (f) a support structure anchoring central generator to outer support structure; and (g) anchoring attachment points on outer support structure.

Preferably the power generation system further comprises one or more of: an anchor system; a tether system attached to said turbine power generation system and said seafloor anchor system; a power cable transferring power generated to said anchor system. Optionally, the power generation system can comprise a keel. In a preferred embodiment, the anchor system is attached to the seafloor and the power generation system has slight positive buoyancy. In an alternative preferred embodiment, the anchor system is attached to a surface vessel or structure and the power generation system has slight negative buoyancy. In another preferred embodiment, the power generation system is attached directly to a structure such as a boat.

A further aspect of the invention provides an array of power generation systems placed on the seafloor to create a distributed power generation network.

A further aspect of the invention provides a submerged turbine desalination system comprising: (a) an outer support structure; (b) a fluid flow enhancing front diffuser portion of the support structure; (c) a fluid flow enhancing aft multi-finned portion of the support structure; (d) turbine blades; (e) a central fluid pump driven by turbine blades; (f) a support structure anchoring central pump to outer support structure; (g) anchoring attachment points on outer support structure; (h) anchor system; and (i) fluid flow lines transferring pressurized water to a reverse osmosis filtration system. An array of submerged turbine desalination system can be anchored to the seafloor to create a desalination plant.

A further aspect of the invention provides a rotating diffuser to accelerate flow through a ducted turbine that is driven round by the fluid flow outside of the duct by hydrodynamic forces acting on the diffuser's hollow fins. Preferably said fins extend out from the duct with an angle of attack to the flow direction as a flowing continuation of its inside and outside surfaces permitting the ready flow of fluid from inside the duct into them, from where the fluid is accelerated centrifugally by the rotation of the diffuser before exiting at the open trailing edges, where it is again accelerated by Venturi effect suction resulting from the trailing edges movement through the fluid.

A further aspect of the invention provides a static diffuser to accelerate flow through a turbine duct with a radial array of convolutions which extend out in a radial spiral. Preferably, such spiral notionally follows the swirl generated by the turbine and expands the flow within the limits of retaining laminar flow. Preferably, the convolutions also modulate forward to back such that they are short in the pit of the convolution where the fluid is the least deflected, and long at the peak where the fluid is deflected by the greatest amount. Preferably, the convolutions are also biased such that the upper face of the spiral convolutions deflects the flow more than the inner face so as to produce a counter-swirl to that produced by the turbine.

### DRAWINGS

The present invention can best be understood in conjunction with the accompanying drawings, in which:

FIG. 1 is an isometric view of the system;

FIG. 2 is an isometric view of the system with an additional torque stabilizing keel;

FIG. 3 is an isometric view of another embodiment of the invention showing an embodiment with ribs and protrusions on the surface to further enhance flow control;

FIG. 4a is an aft view of the system in FIG. 3.

FIG. 4b is an aft isometric view of the system in FIG. 3.

FIG. 5 is an isometric view of an embodiment of the invention specifically optimized for a fixed diffuser with after helical fins and ribs and protrusions on the shroud surface to further enhance flow control.

FIG. 6 is an aft isometric view of the system in FIG. 5.

FIG. 7 shows the invention with an appended tip diffuser.

FIG. 8 shows a variation of the fixed diffuser where the diffuser segment spiral around further.

In the drawings, preferred embodiments of the invention are illustrated by way of example, it being expressly understood that the description and drawings are only for the purpose of illustration and preferred designs, and are not intended as a definition of the limits of the invention.

### DETAILED DESCRIPTION

In summary, a submerged turbine generator system utilizes a multi dimensional shaped shroud to gather, direct, and focus fluid through a turbine generator. This increases the flow speed in the part of the duct in which the turbine rotor sits, and thereby the pressure differential from which energy is extracted from the flow. An aft diffuser, which could optionally have spiral (helical) fins, creates a counter swirl to the swirl created by the turbine's rotation. A preferred embodiment of the invention includes a rotating diffuser with aft helical fins, driven by the fluid that flows external to the cowling. The fins cause rotation because they have the properties of a high thickness aerofoil operating at an angle of attack to the free flow.

The duct surrounding the turbine channels fluid smoothly into internal cavities in the aft helical fins. Some of this fluid is carried around and is accelerated outwards by centrifugal forces generated by the rotation of the helical fins, and ultimately backwards, thereby sucking out more fluid and reducing the pressure in the duct behind the turbine.

The back of the fins are open to allow the fluid to escape. As the fins' trailing edge speed is higher than the internal flow speed, there will be a pressure drop at the trailing edge opening which will help to suck fluid out of the fins' hollow regions and again reduce pressure behind the turbine.

The fluid escaping the rear of the fins is moving slower than the fins so it produces a swirl in the same direction of rotation as the fins. The fins themselves produce a swirl which is counter to their direction of rotation. These two swirls interact, with the swirl energy converted to accelerated flow speed, again reducing fluid pressure in the fins' interior cavities.

These effects are enhanced by convolution features that reduce turbulence and improve the Venturi based suction effect: Convolutions may also be added to the trailing edges of the fins to extend their edge length and thereby enhance their ability to entrain fluid from inside of the fins by promoting inside/outside mixing, helping to energize and expel the internal fluid to reduce the internal fin pressure.

These convolutions may be in the plane of the fin's surface, or beneficially at an angle to this plane such that they modulate backwards and forwards as well as up and down.

In order to promote laminar flow over the rear surface of the fins, the surface may have ridges that flow from the front to back in a spiral array that is roughly parallel to the fins' leading edge. The convolutions lie at an angle to the free fluid flow and are biased in form such that fluid flows up a ramp to a precipice where the low pressure caused by the Venturi effect causes some of the flow to spiral into a vortex which then follows the deepening trough, building strength from more entrained fluid as it goes until the vortex passes beyond the trailing edge. Such vortices have the effect of energizing the boundary layer to promote laminar flow, and once beyond the trailing edge they enhance the mixing of high energy external flow with low energy internal flow.

The leading edge of the cowling may also have tubercles or protrusions. These help to reduce the high pressure zone which would otherwise run around the cowling where the surface is normal to the flow direction. They also generate surface vortices that again help the flow follow a downward curve into a low pressure region. When operating in slow flow marine conditions, the effects of skin and form drag are reduced, enabling the fin design compromise to be drawn in favor of larger surface area solutions.

As well as increasing the aspect ratio of the fins to improve their lift/drag performance and hence increase their rotational speed, more of the fluid can be obliged to accelerate within the fin rather than being able to pass relatively unaffected out of the central axis area. This is accomplished by extending the trailing edges of the fins closer to the tapering pod that otherwise retains the rotor. Further internal flow channels can be arranged to divert the axial flow behind the turbine directly into the radial fins, only letting the flow exit from an opening in the fin trailing edge after it has gained some centrifugal acceleration.

Such tailoring to given flow conditions may be accommodated by having alternative front cowls and aft diffusers that may be interchanged to enable the preferred performance characteristics. This feature is particularly advantageous on small scale systems as may be employed by boat owners. A large diameter aft rotating helical fin diffuser will be better able to extract power from slow speed current flows as may be available at a mooring. A smaller lower drag fixed diffuser will be adequate if used under way at higher cruising speeds or a mooring in a strong current.

At the expense of a loss of some flow speed enhancement, but also at the gain of simplicity, the diffuser could be a static artifact otherwise part of the front flared cowling.

In order to better utilize the Venturi effect to draw more fluid through the turbine, the diffuser is segmented by convolutions to reach more of its contained volume. This invention thus includes aligning the convolutions with the internal swirl caused by the turbine to project a spiral fluid path that is longer therefore less steep while not adding to the diffusers length and diameter. Extending out in a spiral curve also results in them enclosing a greater cross sectional area for a smaller outside diameter than they would if they simply extended out radially. Beneficially the trailing edge of the diffuser modulates from front to back, such that where the flow is deflected by the least amount the diffuser is shorter, and where deflected by a greater amount the diffuser is longer. This also serves to minimise surface area and hence skin friction. The multi-dimensional trailing edge convolutions generate a significantly increased trailing edge length to enhance the Venturi suction.

The fins can be hydrodynamically designed with a bias such that one of the fin faces is more normal to the flow and becomes significantly larger than the other. This larger fin face then deflects the flow into a rearward swirl that can exactly counter the turbine generated swirl exiting from inside the diffuser. In addition, the spiral convolutions can have ridges that are biased to provide a soft ramp in the flow direction followed by a steep precipice. These first guide the fluid but then as they present an increasing angle to the flow will generate vortices that will improve the mixing of high energy external flow with low energy internal flow at the trailing edge (similar to the process employed in an embodiment of the rotating diffuser concept). The ridges terminate at an angle to the fin face, creating further ripples that modulate to a degree parallel to the fin face, further adding to the trailing edge length with subsequent flow mixing benefits. These ridges will also stiffen the shell in the same way that clam shells use similar ridges.

The leading edge of the cowling may feature tubercle like protrusions which break up the flow such as to reduce the size of the high pressure zone that is normal to the flow between the upper and lower cowling surfaces. The resulting small flow deflections again generate vortices which help to maintain laminar flow in the low pressure area behind the leading edge. While tubercles have been explored for use in wing sections, this invention teaches their use for a cowling leading flow into a duct.

A circumscribing secondary wing may be added which will capture more external flow and oblige it to accelerate as it passes over the trailing edge. The increased flow speed will enhance the Venturi suction effect. This wing may beneficially track the diffusers' trailing edge so to maximise flow acceleration through the gap between the wing and diffuser. Such a modulating ring wing may also feature tubercles along its leading edge.

Electrical power can be generated, or the turbines can drive a pump to create the 60 bar pressure required to pump non-fresh water through a reverse osmosis filtration system to generate fresh water. This can be especially useful for watercraft. An array of systems can also be placed offshore in arid climates and the water from many units pumped through low cost pipes to a central desalination plant.

In order to provide a more economical solution to converting the power produced into electricity, rather than individual electric generators for each turbine, the turbine could utilize a hydraulic motor that pushes fluid into an energy storage device. The energy store can then be shared amongst a ‘field’ of turbines, connected by high pressure tubing. The store can then contain a further hydraulic motor that can drive an electric generator at a constant duty cycle. By this means the electrical generation infrastructure can enjoy better utilization with subsequent cost benefits. Also the expensive generation equipment need not be at risk behind rotating sea water seals.

The hydraulic motor can be of a style that enables variable displacement so as to better match the torque to the flow speed. This adjustment can be effected automatically by sensing the line drag and using it to change the displacement such that at high drag the displacement is proportionally increased. This process can occur by introducing a hydraulic cylinder into an axially elastic portion of the retaining line, and using the cylinders displaced fluid to directly adjust the motor's displacement.

Such a store can take the form of a vessel that retains a gas at an internal pressure, into which the fluid is compressed, or a flask from which the fluid is evacuated leaving a high partial vacuum. The former option requires a vessel able to sustain tension and thus is not ideally suited to low cost concrete. The latter option has its vessel in compression so is well suited to concrete, but requires a significant installed depth in order to facilitate a high enough pressure differential to keep it manageably compact.

Certain features of the diffuser utilise the design evolution of marine nature to improve its performance:
Tubercles like from the leading edges of whale fins which extend control by being able to manage greater angles of attack before stalling.
Long vortex inducing ridges like from the belly of large filter feeders to preserve laminar flow around their bodies behind their gaping mouths.
Smaller modulations on the trailing edge similar to those employed by sea lions etc to create trailing edge vortices that reduce turbulence.
Clam shell stiffening.

Preferred embodiments of the invention will now be described with reference to the drawings.

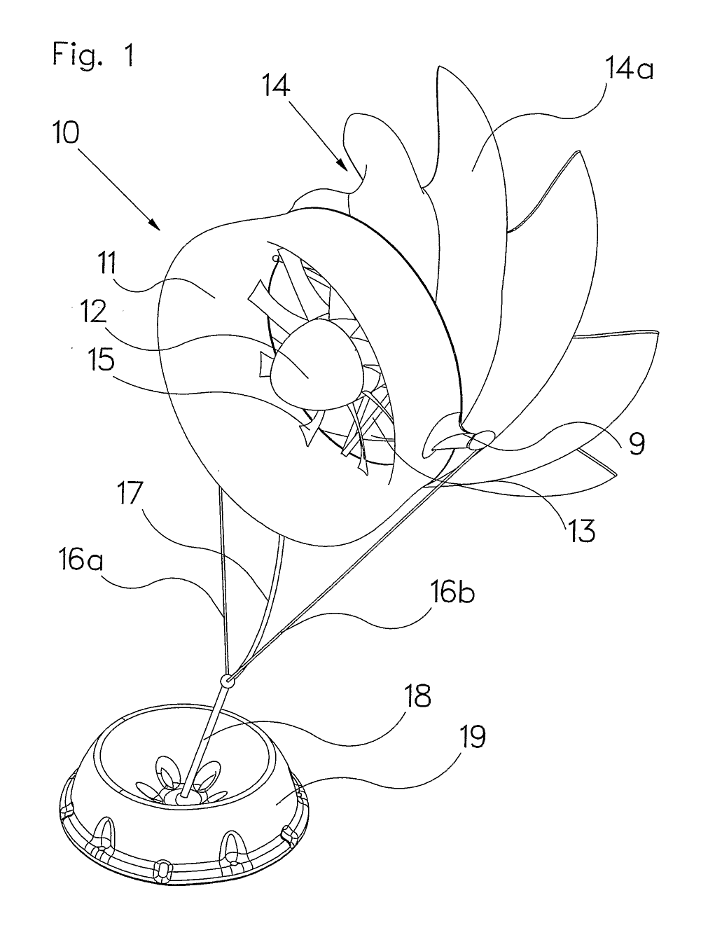

FIG. 1 shows the first embodiment of the invention 10, a submerged tethered turbine generator system. The cowling and duct 11 appear normal enough as is known skilled in the art but the aft diffuser 14 has vanes (fins) such as 14a which cause it to rotate and accelerate the flow through the duct. The augmented flow passes through the center of the shroud past the turbine blades 15 which are optimized for flow inside a duct. To maximize underwater system reliability, they should be fixed pitch, but if maximum efficiency is needed, particularly for larger system operating where currents vary, they could be made variable pitch. The turbine blades spin a generator in the core 12 which is held to the duct by struts 13. The struts can be very thin like spokes to minimally impact the flow, or they could be in the form of stator blades to further enhance the flow.

The diffuser 14 may be attached to the duct such as to be able to spin freely on its axis by various means. In one embodiment the diffuser is attached by traditional rotary bearings which can be of large diameter on the duct, or at the center and then the diffuser is held in place radially by spokes 13. An array of spokes can be used, so they are simple tension/compression members, but then there are more features for seaweed to entangle, and hence only one or two pylon-type structures may be used to hold the center 12 to the shroud. The diffuser can also have magnets attracting it to the cowling, and tension members pulling it back to a swivel point retained at the end of the central pod. In another embodiment the diffuser has rollers around its rim preloaded by swiveling tension members.

The system is held in position underwater by tethers 16a and 16b that attach to ears 9 (only one is shown) near the middle of the shroud so it will fly horizontally even in a current. Beneficially the tether points will lie just below the middle of the duct where drag on the shroud will cause it to tilt backwards fighting the righting buoyancy and giving it an overall angle of attack to the horizontal fluid flow. This will add more lift to counteract the effect of being carried backwards and downwards by the current. Tethers 16a and 16b converge to a single line 18 which is attached via a swivel (not shown but standard for buoys) to a base 19 that is anchored to the seafloor. The anchoring can be by shear weight, or it can be attached by piles or by traditional anchoring methods in accordance with the seafloor conditions. Power from the generator is transmitted to the base 19 by power cable 17 which is held by the tether 18.

Collection of the power from many such systems 10 would be via a grid on the seafloor. Generator 19 can be a DC generator, where power electronics are housed in either the hub or the base 19. DC power underwater minimizes losses due to field effects in seawater which is a strong dielectric. The power electronics for such conditions have been developed for offshore wind turbine systems and conventional underwater turbines and can be applied here.

The design of the cowling and duct 11 and the diffuser 14 with aft helical fins 14a must be done in conjunction with each other, and computational fluid dynamics analysis software is best employed to create the optimum shapes and number of fins for the size of the system and also for the flow to be encountered. Here 7 aft helical fins are shown but more smaller fins may be desirable.

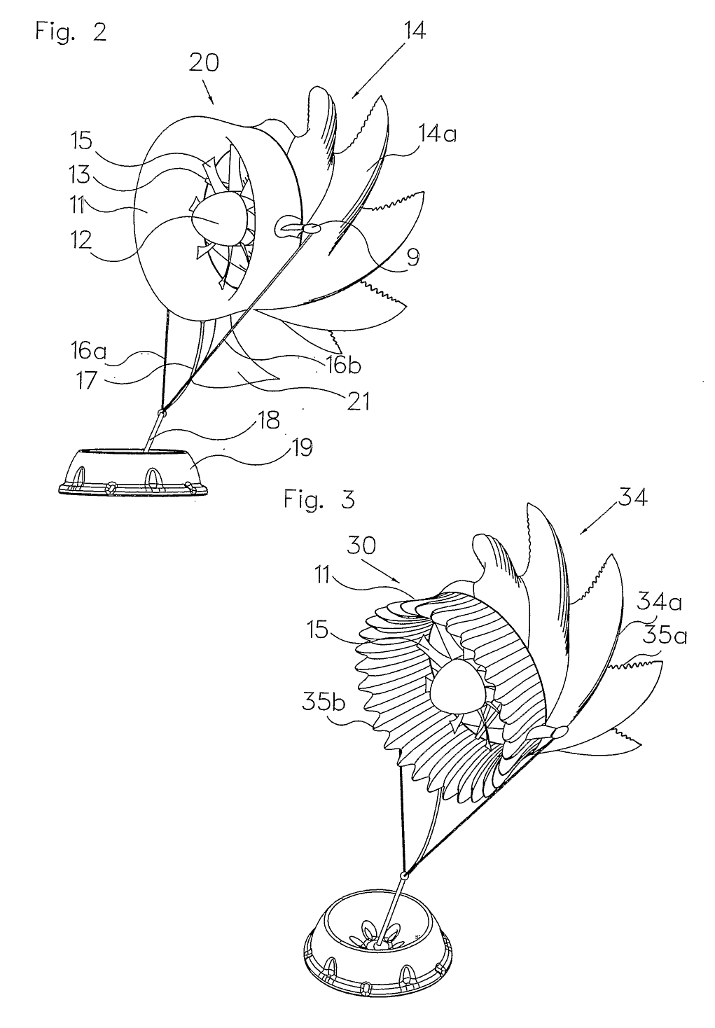

FIG. 2 shows a similar system 20 with the addition of a keel 21 which helps to move the center of mass further below the center of buoyancy to enhance stability, and the keel itself, as in a sailboat, dynamically also helps stabilize the roll of the system and helps the system fly straight into the current.

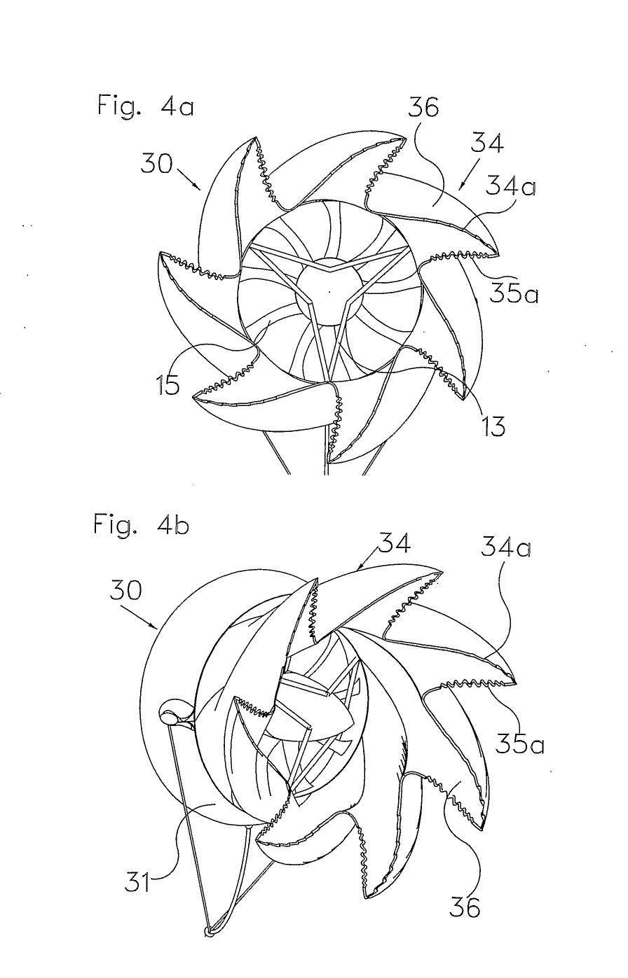

FIGS. 3, 4a, and 4b show another embodiment 30 of the invention with added ribs 34 and protrusions 35a on the fins 14a to further enhance flow control. Note that the fins are thin structures such that there is an interior space 36 that helps to create the swirling action that in effect pumps water through the inside of the cowling and duct 31 so more power can be extracted by the blades 35 from the flowstream. In addition, protrusions 35b on the leading edge of the cowling and duct 31 further add to flow performance as inspired by nodules on whales. These “tubercles” (bumps) can be placed on the leading edge of the cowling and duct 31 can reduce leading edge drag and help suck in the flow over the lip of the cowling (diffuser). As an example from nature, see www.whalepower.com, and is also described in relation to wings rather than the herein discussed cowl in US pending patent publication number US2006/0060721, published Mar. 23, 2006.

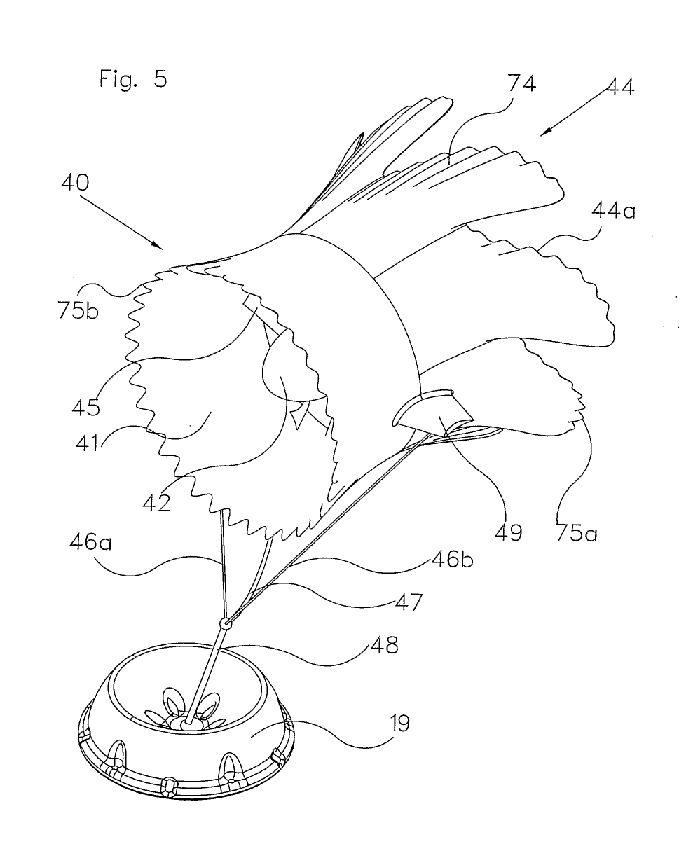

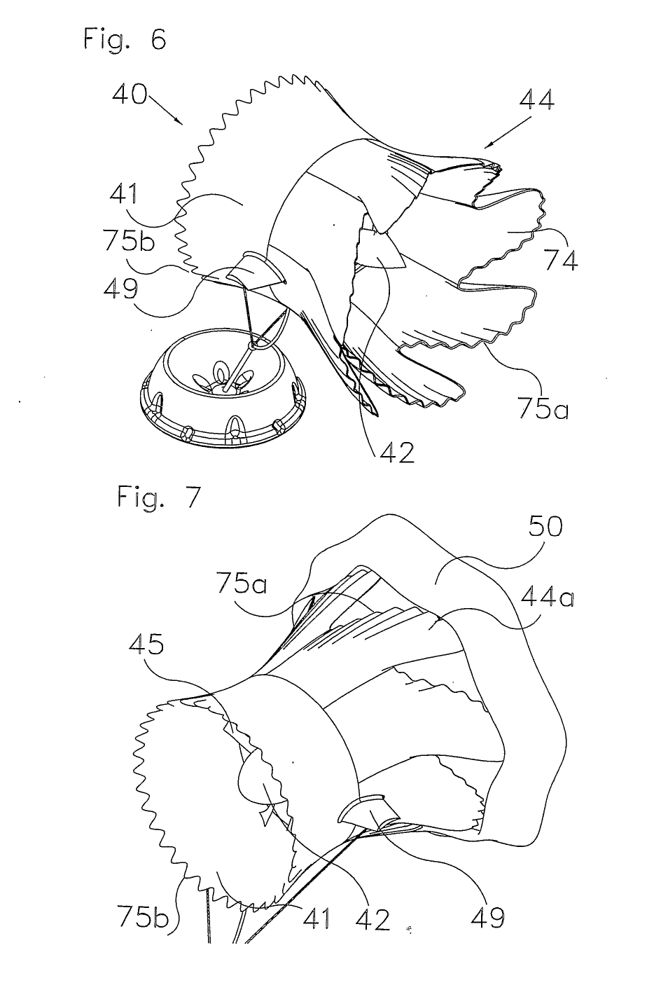

In the above figures and embodiments, the diffusers are generally rotating but can be fixed to the duct. FIGS. 5 and 6 show an embodiment 40 specifically designed to be of a non-rotating diffuser type. The base 19 is anchored to the seafloor as before, and tethers 46a and 46b attached to anchor wings 49 hold the system 40 to the base 19 via a line 48. Tubercles 75b help to augment the flow into the cowling. The flow enters the cowling and duct 41 and flows past the turbine blades 45 causing them to spin and generate power. Power generated by the turbine in center structure 42 which is held to the duct 41 by struts 43 is transmitted via cable 47. The aft diffuser section 44 has fixed fins such as 44a with ridges 74 and bumps 75a to further enhance the flow.

FIG. 7 shows the embodiment of FIG. 5 with an added winglet 50 attached to the ends of the fins 44a. This winglet further enhances the flow, although in an underwater environment, it may need to be periodically cleaned of floating debris.

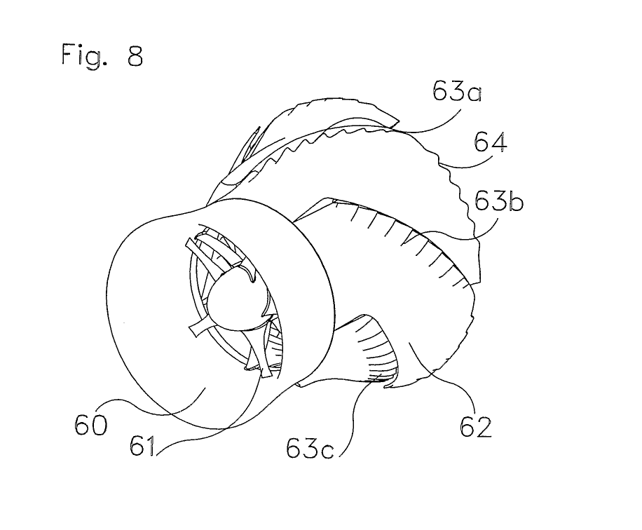

FIG. 8 shows a variation of the previous embodiment of a fixed diffuser. The turbine 61 operates in duct 60 with diffuser segments e.g. 64 curling around in a counter swirl direction. The trailing edge of the leading wing overlaps the leading edge of the next wing to induce high energy flow through the gap and thereby energize the boundary layer within the duct in order to maintain laminar flow. In this embodiment there are tapered ridges that emerge from the wing and deepen as they curve around to join the trailing edge. These ridges are at an angle to the external flow in order to induce the formation of vortices as the flow roles over the edge. These vortices further assist in maintaining laminar flow.

Further modifications of the invention will also occur to persons skilled in the art, and all such are deemed to fall within the spirit and scope of the invention as defined by the appended claims.

1-21. (canceled)

22. A marine turbine generator comprising:
a turbine;
a duct surrounding the turbine; and
a rotating diffuser having fins,
wherein the fins extend out from the duct with an angle of attack to the flow direction, have open trailing edges and define cavities which extend in a radial direction from the center of the diffuser;
wherein the diffuser is arranged to accelerate flow through the duct, the diffuser being driven round by the fluid flow outside of the duct by hydrodynamic forces acting on the fins; and
wherein the flow of fluid from inside the duct is directed into the cavities, from where the fluid is accelerated centrifugally by the rotation of the diffuser before exiting at the open trailing edges where it is again accelerated by Venturi effect suction resulting from the trailing edges movement through the fluid.

23. The marine turbine of claim 22, wherein the trailing edges modulate backwards and forwards and/or up and down, being then blended into a surface of the diffuser.

24. The marine turbine of claim 23, wherein the trailing edges are modulated by secondary convolutions.

25. The marine turbine of claim 23, wherein the trailing edges are circumscribed by a secondary radial significantly following a sweep of the trailing edge, such wing having the form of an inverted aerofoil operating at a negative angle of attack to the direction of a prevailing fluid flow.

26. The marine turbine of claim 22, wherein the duct has a leading edge, the leading edge being provided with tubercle-like protrusions that alternatively advance and retard the leading edge.

27. The marine turbine of claim 22, wherein the fin is provided with convolutions, the convolutions being formed of a ridge, the ridge having a soft climb ramp followed by a steep precipice.

28. A marine turbine generator comprising:
a turbine;
a duct surrounding the turbine; and
a static diffuser provided with a radial array of convolutions which extend out in a radial spiral, wherein the convolutions are arranged to expand the flow though the duct within the limits of retaining laminar flow, and wherein the convolutions are biased so as to produce a counter-swirl to that produced by the turbine.

29. The marine turbine of claim 28, wherein the convolutions have trailing edges, and wherein the trailing edges are modulated by secondary convolutions in a direction which is normal or tangential to a surface of the fins.

30. The marine turbine of claim 29, wherein the secondary convolutions are modulated by tertiary convolutions.

31. The marine turbine of claim 28, wherein the convolutions are circumscribed by a secondary radial wing significantly following a sweep of the trailing edge, such wing having the form of an inverted aerofoil operating at a negative angle of attack to a prevailing fluid flow.

32. The marine turbine of claim 28, wherein the duct has a leading edge, the leading edge being provided with tubercle-like protrusions that alternatively advance and retard the leading edge.

33. The marine turbine of claim 28, wherein the convolutions are formed of a ridge, the ridge having a soft climb ramp followed by a steep precipice.

34. A submerged turbine power generation system comprising:
a marine turbine generator; and
a harness for anchoring said marine turbine generator to a seabed, wherein the marine turbine generator is attached to the harness to fly such that it naturally lines up into the prevailing fluid flow and sustains its elevation by using both buoyancy and hydrodynamic lift forces that vary in proportion to flow speed.

35. The submerged turbine power generation system of claim 34, further comprising at least a second marine turbine generator vertically arranged in a stack to be retained by a single anchor point.

36. The marine turbine of claim 22 further comprising any one or more of:
a line for restraining the marine turbine to an anchor point on a sea bed;
a power cable for transferring power generated to an anchor point;
a keel;
a central electrical generator driven by turbine blades;
a central fluid pump driven by turbine blades;
support structure anchoring generator or pump to outer support structure;
anchoring attachment points on an outer support structure;
an anchor system; and/or
fluid flow lines transferring pressurized water to a reverse osmosis filtration system.

37. The marine turbine of claim 28 further comprising any one or more of:
a line for restraining the marine turbine to an anchor point on a sea bed;
a power cable for transferring power generated to an anchor point;
a keel;
a central electrical generator driven by turbine blades;
a central fluid pump driven by turbine blades;
support structure anchoring generator or pump to outer support structure;
anchoring attachment points on an outer support structure;
an anchor system; and/or
fluid flow lines transferring pressurized water to a reverse osmosis filtration system.

38. A marine turbine system in accordance with claim 34, comprising multiple submerged turbine power generator devices, wherein each generator device has its own variable capacity hydraulic pump connected by pressure line to a common gas filled pressure reservoir, and wherein the pressure reservoir has a hydraulic motor that drives an electric generator at constant rate or on demand as it releases the pressurized water.

39. A marine turbine power generation system in accordance with claim 34, comprising multiple submerged generator devices, each generator having its own variable capacity hydraulic pump connected by pressure line to a pressure vessel otherwise water filled but able to be evacuated against the resulting near vacuum, the pressure reservoir having a hydraulic motor that drives an electric generator at constant rate or on demand as it returns water into the evacuated space.
